(19) United States
(12) Patent Application Publication
(10) Pub. No.: US 2008/0265777 A1
(43) Pub. Date: Oct. 30, 2008

(54) Lamp with Closing Means in Case of an Explosion of the Burner

(75) Inventors: Arnd Ritz, Heinsberg (DE); Holger Moench, Vaals (NL); Jens Pollmann-Retsch, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,189

(22) PCT Filed: May 26, 2004
(86) PCT No.: PCT/IB05/51631

§ 371 Date: Nov. 16, 2006

(30) Foreign Application Priority Data
May 26, 2004 (EP) 04102305.2

(51) Int. Cl. H01J 61/56

(52) U.S. Cl. 313/639

(57) ABSTRACT

The invention relates to a lamp, e.g. a UHP-Lamp, comprising a burner with an ionizable filling and an amount of mercury contained therein, having at least one closing means (40, 50) which closes immediately and/or hermetically and/or irreversibly all in- and/or outlets of the lamp to enclose the mercury in the lamp upon detection of an explosion of the burner.

The present invention relates to a lamp containing mercury, e.g. an UHP (Ultrahigh-pressure) lamp.

In present art UHP lamps, it is necessary to use mercury to achieve proper operation of the lamp. Although the amounts used are merely in the range of 10-20 mg per lamp, there has been a growing concern that in case of an explosion of the lamp, the environment of the lamp might be exposed to and contaminated by the mercury. Such explosions can up to date never be avoided, even with the highest standard lamps. The main two reasons for such lamp explosions are:
1.) The explosion takes place when the lifetime of the lamp has nearly ended due to blow-up because of recrystallisation of the quartz bulb. By monitoring the lamp voltage, these blow-ups can be avoided, if the lamp is switched off, when certain criteria are met. A control device is e.g. disclosed in the EP 1 076 478.
2.) The explosion takes place due to tension in the quartz. This can up to date not be detected and may lead to explosion during any time the bulb is operated.

Since the risk of an explosion of the lamp cannot be eliminated, it must be taken care that the mercury contained inside the lamp is not released to the environment, if such an explosion happens.

Therefore there have been several attempts to provide a lamp with a sealing or cutoff-mechanism which will close any in- and/or outlets of the lamp in case of an explosion, e.g. in the US 2003/0071977 A1 and the JP 2002 333 670 which are hereby fully incorporated by reference. However the mechanisms as proposed in these documents fail to secure that all mercury is sealed in the lamp in case of an explosion.

It is therefore an object of the present invention to provide a device which is capable of effectively hindering the mercury contained in the lamp to advance to the environment of the lamp in case an explosion happens.

These objects are achieved by a lamp as disclosed in claim 1 of the application. Accordingly, a lamp comprising a burner with an ionizable filling and an amount of mercury contained therein is provided, which comprises at least one closing means which closes, immediately and/or hermetically and/or irreversibly all in- and/or outlets of the lamp to enclose the mercury in the lamp upon detection of an explosion of the burner. The term “immediately” in the sense of the present invention means, that the in- and/or outlets of the lamp are closed within ≧0 ms and ≦1 s, preferably within ≧0 ms and ≦100 ms after the explosion of the burner. The terms “hermetically” and “irreversibly” in the sense of the present invention mean in particular that the in- and/or outlets of the lamp are closed in such a way that this closing may not be opened simply by e.g. moving a valve or shifting a lid. This is especially important during lamp replacement and disposal.

The term “detection” in the sense of the present invention means in particular, that the closing means closes the in- and/outlets of the lamp in reaction to a change in the lamp characteristics (e.g. the inner pressure and/or the lamp voltage). The closing means may include a detection means in form of a measuring and/or analyzing means or device; however, for some applications this may not be needed.

In a preferred embodiment of the present invention the explosion of the burner is detected via a sudden change in the lamp characteristics, preferably via a sudden change in the lamp voltage and/or lamp current. When, e.g. in UHP-lamps the burner of the lamp explodes, there will be a sudden change in lamp voltage. This effect can be used for causing the closing means to close the in- and/or outlets of the lamp.

Changes in the lamp characteristics which may be used for detection are as follows:
Increase of lamp voltage of ≧50 V, preferably ≧100 V and ≦500V for ≧1 ms and ≦1 s and/or
Increase to 75% of the open loop voltage for ≧1 ms and ≦1 s and/or
Decrease in the lamp current of ≧50% and ≦100% compared to the nominal current for ≧10 ms, preferably ≧20 ms, and ≦1 s.

In a preferred embodiment of the present invention an explosion of the burner is detected via a shockwave caused by the explosion of the burner. Preferably, the inner pressure of the burner in lamps to be used within the present invention is within ≧20 bar and ≦500 bar, more preferably within ≧40 bar and ≦300 bar. The inner volume of the burner in lamps to be used within the present invention is within ≧10 mm² and ≧1000 mm², more preferably within ≧20 mm² and ≦500 mm². The inner volume of the reflector room of the lamp is within ≧10 cm² and ≦1000 cm², preferably within ≧20 cm² and ≦500 cm². So upon explosion of the burner, there will be a shockwave due to the high inner pressure of the burner. This shockwave may be used to cause the closing means to close the in- and/or outlets of the lamp.

According to a preferred embodiment of the present invention, the inner diameter of the in- and/or outlet is preferably within ≧0.1 mm and ≦10 mm, more preferably within ≧0.5 mm and ≦5 mm.

In a preferred embodiment of the present invention the in- and/or outlets of the lamp are closed by melting of a melting means, which melts, preferably due to a current source upon detection of an explosion of the burner. In a preferred embodiment of the present invention the lamp comprises a heating means which heats the melting means upon detection of an explosion of the burner.

This melting means and/or heating means are preferably designed in such that the in- and/or outlets of the lamp comprise a nozzle made out of a material which has a rather low melting point. When the explosion of the burner occurs, the nozzle is heated and melts, therefore closing the in- and/or outlets of the lamp. In order to achieve this, the nozzle is preferably equipped with a heating means in form of a heating coil or a spiral, which effectively heats up the nozzle within milliseconds. Preferably, the whole in- and/or outlets of the lamp comprise out of a material with a low melting point, which is preferably chosen in such, that during usual operation of the lamp, no melting occurs. Preferably, the melting point is within ≧200° C. and ≦600° C., more preferably within ≧250° C. and ≦450° C.

Preferably, the material is selected from a group comprising thermoplastics, soldering glasses and mixtures thereof. In order to achieve a proper closing of the in- and/or outlet of the lamp, the inner diameter of the in- and/or outlet is preferably within ≧0.1 mm and ≦10 mm, more preferably within ≧0.5 mm and ≦5 mm.

Alternatively or additionally, the melting means and/or heating means are preferably designed in such a way, that the in- and/or outlets of the lamp comprise a heating filament, preferably in form of a coil or spiral placed inside a tube. This filament will then be melted, in case an explosion occurs. Preferably, as described above this filament comprises out of a material with a low melting point, which is preferably chosen in such, that during usual operation of the lamp, no melting occurs. Preferably, the melting point is within ≧200° C. and ≦600° C., more preferably within ≧250° C. and ≦450° C. In order to achieve a proper closing of the in- and/or outlet of the lamp, the inner diameter of the tube, which is part of the in- and/or outlet is preferably within ≧0.1 mm and ≦10 mm, more preferably within ≧0.5 mm and ≦5 mm. Furthermore, the tube, in which the heating filament is placed, is preferably made out of a material which is non-conductive and comprises glass, ceramics or mixtures thereof.

Alternatively or additionally, the melting means and/or heating means are preferably designed in such a way, that the in- and/or outlets of the lamp comprise a heating filament, preferably in form of a coil or spiral placed outside a tube, which is from the inside coated with a material with a low melting point. In this case, the filament will heat the tube, which then causes the material to melt. The filament and the tube stay intact. Preferably, the melting point of this material is within ≧200° C. and ≦600° C., more preferably within ≧250° C. and ≦450° C. In order to achieve a proper closing of the in- and/or outlet of the lamp, the inner diameter of the tube, which is part of the in- and/or outlet is preferably within ≧0.1 mm and ≦10 mm, more preferably within ≧0.5 mm and ≦5 mm. Furthermore, the tube, in which the heating filament is placed, is preferably made out of a material which is non-conductive and comprises glass, ceramics or mixtures thereof.

In a preferred embodiment of the present invention the lamp comprises at least one sealing means located in the in- and/or outlets of the lamp, which upon detection of an explosion of the burner, seals the in- and/or outlets of the lamp. Sealing in the sense of the present invention means in particular that at least one part of the in- and/or outlets of the lamp, the sealing means extends itself and/or fills the whole diameter of the in- and/or outlet. Preferably the sealing is done hermetically, in particular in that the seal cannot reopen spontaneously and/or from itself after the sealing occurred. This can e.g. be achieved by
mechanical means (e.g. the seal moves over a pressure point, behind which the inverted movement is impossible)
and/or by a sticky surface of either the seal and/or the in- and/or outlets of the lamp
and/or or by proper construction of the geometrical dimensions of the seal and/or the in- and/or outlets of the lamp.

In order to achieve a proper closing of the in- and/or outlet of the lamp, the inner diameter of the tube, which is part of the in- and/or outlet is preferably within ≧0.1 mm and ≦10 mm, more preferably within ≧0.5 mm and ≦5 mm. Preferably the sealing means comprises a material which is designed in such a way that it tightly fills the in- and/or outlet of the lamp. Preferably the material of the sealing means is chosen from a group comprising silicon, PTFE or Kalrez® or mixtures thereof. Alternatively or additionally, the sealing means may be caused to melt at least partially when sealing the in- and/or outlet of the tube in order for a more tight sealing.

In a preferred embodiment of the present invention the sealing means comprises at least one retaining means, which hold the sealing means in a position, which allows fluid to flow through the in- and/or outlets of the lamp in case the burner of the lamp is in usual operation but allow the sealing means to seal the in- and/or outlets of the lamp in case the burner explodes.

In a preferred embodiment of the present invention the sealing means is caused and/or forced to seal the in- and/or outlets of the lamp by the shockwave of the burner explosion in case the burner explodes. Preferably, the shockwave presses the sealing means into a position where it seals the in- and/or outlets of the lamp.

In a preferred embodiment of the present invention the force of said retaining means is chosen in such that the retaining means hold the sealing in a position, which allows fluid to flow through the in- and/or outlets of the lamp in case the burner of the lamp is in usual operation, but is overcome by the forces caused by the shockwave of the burner explosion in case the burner explodes in order for the sealing means to seal the in- and/or outlets of the lamp. This can e.g. preferably be achieved by using springs as retaining means, which hold the sealing means in the in- and/or outlet of the lamp, but which spring force is so weak that the shockwave is able to overcome it and press the sealing means to seal the in and outlet of the lamp in case an explosion occurs.

In a preferred embodiment of the present invention, the closing means comprise at least one first closing means, which immediately closes the in- and/or outlets of the lamp and at least one second closing means, which closes hermetically and/or irreversibely the in- and outlets of the lamp. For some applications, it may be disadvantageous or even impossible to provide a closing means, which closes the in- and/outlets immediately and hermetically and/or irreversibly all in one. In this case it is preferred, that the closing means comprise at least one first closing means, which has a very quick reaction time and therefore closes the in- and/or outlets of the lamp immediately after detection of an explosion of the burner of the lamp. A second closing means with a longer reaction time may then assist the first closing means in hermetically and/or irreversibly closing the in- and/or outlets of the lamp.

In a preferred embodiment of the present invention, the closing means may comprise a warning and/or signaling means, which issues a warning signal upon detection of an explosion of the burner of the lamp. Especially in the case, when the explosion of the burner is detected via a change in the lamp characteristics, e.g. the lamp voltage and/or current, this warning signal may be issued in an easy way.

The detection of the explosion of a burner by the electronic lamp driver will result in a main action of the closing means, which immediately and/or hermetically and/or irreversibly closes the in- and/or outlets of the lamp. In addition a warning signal is issued to trigger other measures as e.g. a failure indication on the display of the projection system, an alarm tone, even a smell, messages to a service team etc.

It should be noted that according to a preferred embodiment of the pre-sent invention, the closing means comprise both at least one sealing means and at least one melting means. This has proven to be most effective for some applications. Furthermore, the warning and/or signaling means may be added additionally.

A lamp according to the present invention is preferably incorporated in a system which is designed for the usage in one or more of the following applications:

shop lighting,

home lighting,

head lamps

accent lighting,

spot lighting,

theater lighting,

Office lighting

Illumination of workplaces

Automotive front lighting

Automotive auxiliary lighting

Automotive interior lighting

consumer TV applications,

fiber-optics applications, and

projection systems

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—show several preferred embodiments of a lamp according to the invention with a closing device.

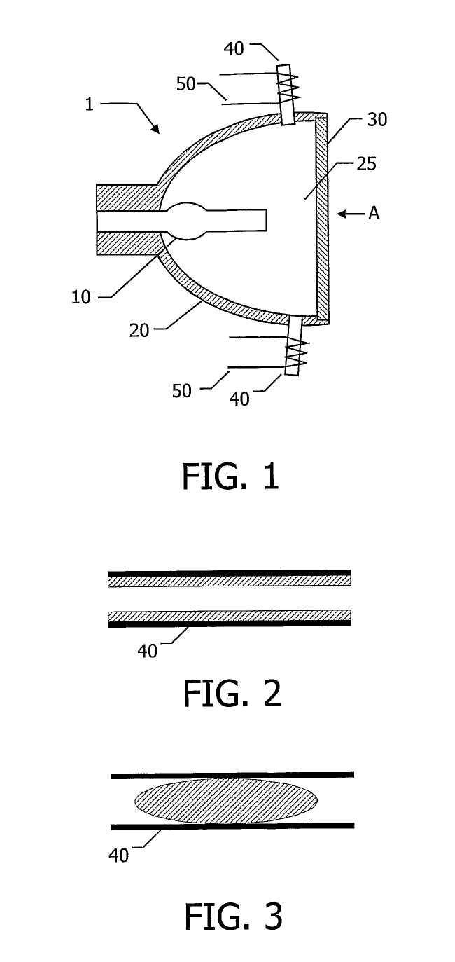

FIG. 1 shows a cross-sectional schematic view of a first embodiment of a lamp according to the present invention

FIG. 2 shows a detailed longitudinal section of the in- and/or outlet of the lamp of FIG. 1

FIG. 3 shows the same view as FIG. 2 after an explosion of the burner occurred.

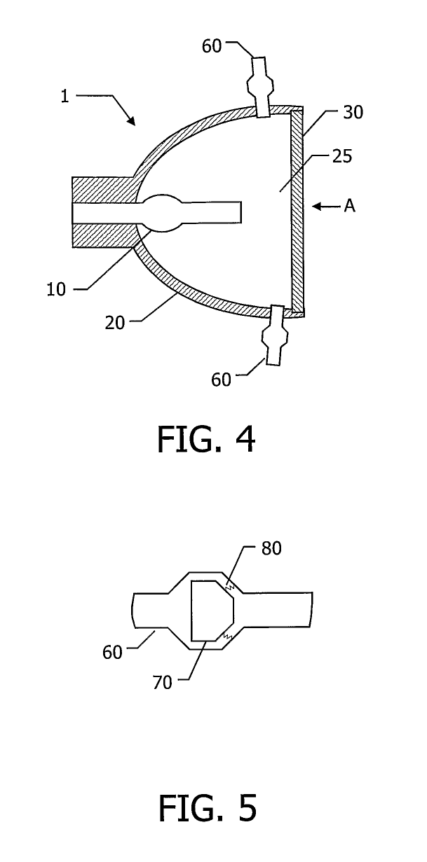

FIG. 4 shows a cross-sectional schematic view of a second embodiment of the lamp according to the present invention

FIG. 5 shows a schematic detailed longitudinal section of the in- and/or outlet of the lamp of FIG. 4.

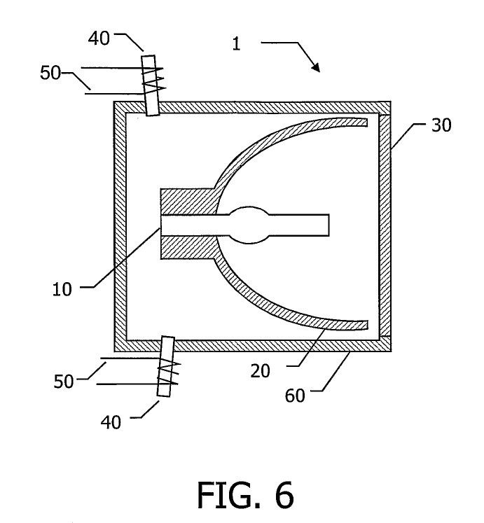

FIG. 6 shows a cross-sectional schematic view of a third embodiment of a lamp according to the present invention.

FIG. 1 shows a cross-sectional schematic view of a first embodiment of a lamp according to the present invention. The lamp 1 comprises a burner 10, a reflector 20, a front glass 30, and two in- and/or outlets 40. These in- and/or outlets 40 lead a fluid, preferably cool air to the burner, which e.g. in UHP-lamps needs to be cooled during usual operation of the lamp. It should be noted, that the number, size and the direction of the in- and/or outlets may vary from application to application.

Reflector 20 and front glass 30 form a reflector room 25. The in. and outlets 40 are surrounded by heating filaments 50. As can be seen from FIG. 2, the in- and/or outlets are inwardly covered by a material which has a melting point chosen in such a way that during usual operation of the lamp, no melting occurs, but a melting can be effected easily by the heating filaments.

In case an explosion of the burner 10 occurs, the heating filament will heat up the in- and/or outlets 40. Preferably, the increase in lamp voltage, which is caused by the explosion of the burner 10 triggers the heating of the filaments 50. Then the inner material of the in- and/or outlets will melt and close the in- and/or outlets, as can be seen from FIG. 3. All mercury which was contained in the burner 10 will then stay in the reflector room 25 and not be released to the environment of the lamp. Due to the irreversible and hermetically closing of the lamp, it is guaranteed that no mercury will leave the lamp even after hours or days.

However, it should be noted that this is only one alternative for effecting a proper closing of the in- and/or outlets of the lamp. Possible alternative or additional closing mechanisms have been describe above and include that the in- and/or outlet 40 itself may melt or that the heating filament 50 may be provided inside the in- and/or outlet 40 for melting in case of an explosion.

FIG. 4 shows a cross-sectional schematic view of a second embodiment of the lamp according to the present invention. This lamp 1 is more or less identical to the lamp of FIG. 1 and therefore not described in greater detail once more. However, the in- and/or outlets 60 are differently designed as can be seen also from FIG. 5, which shows a schematic detailed longitudinal section of the in- and/or outlet of the lamp of FIG. 4. As can be seen from FIG. 5, the in- and/or outlet 60 comprises a sealing means 70, which is held by two retaining means 80 in form of springs in a position that allows a fluid, preferably cold air to flow around it towards or from the reflector room 25. In case of a shockwave due to an explosion of the burner, the sealing means 70 is pressed in the direction of the arrow of FIG. 5. Due to the design of the in- and/or outlet 60, the sealing means is pressed in the in- and/or outlet in such a way that it tightly seals the in- and/or outlet 60. The retaining means 80, which are in this embodiment two springs, are so weak that the shockwave may easily overcome their retaining force in order to effect a proper sealing of the in- and/or outlet. Furthermore, the sealing means 70 comprises a somewhat flexible material to tightly press on the in- and/or outlet 60. Preferably the sealing means is made of a material chosen from a group comprising silicon, PTFE or Kalrez® or mixtures thereof. As a result, the sealing means tightly seals the in- and/or outlet 60.

It should be noted, that in order to increase the tightness of the sealing by the sealing member, the in- and/or outlet 60 may also comprise heating means, which to a certain extent or totally melt the sealing means 70. By doing so, a more tight sealing of the in- and/or outlet may be achieved. It should be noted, that also via the sealing means 70, an hermetically and/or irreversibly sealing of the in- and/or outlets of the lamp is achieved, since the sealing means 70 tightly presses itself inside the in- and/outlets 60 of the lamp.

FIG. 6 shows a cross-sectional schematic view of a third embodiment of a lamp according to the present invention. This lamp differs from the lamp according to the embodiments shown before that it comprises a housing 60, in which the burner 10 and the reflector 20 are located. In the case that the lamp comprises such a housing, the in- and outlets of the lamp are provided at the housing and it is therefore preferred that the in- and outlets 40 of the lamp are provided with closing means such as a heating filament 50. It is obvious, that in this embodiment, the in- and/or outlets of the lamp could also alternatively or additionally be provided to have a sealing means 70 as shown in the second embodiment.

1. Lamp (1) comprising a burner (10) with an ionizable filling and an amount of mercury contained therein, having at least one closing means which closes immediately and/or hermetically and/or irreversibly all in- and/or outlets of the lamp to enclose the mercury in the lamp (1) upon detection of an explosion of the burner (10).

2. The lamp according to claim 1 wherein an explosion of the burner is detected via a sudden change in the lamp characteristics, preferably via a sudden change in the lamp voltage and/or lamp current.

3. The lamp according to claim 1, wherein an explosion of the burner (10) is detected via a shockwave caused by the explosion of the burner.

4. The lamp according to claim 1, wherein the in- and/or outlets of the lamp are closed by melting of a melting means, which melts, preferably due to a current source upon detection of an explosion of the burner (10).

5. The lamp according to claim 1, wherein the lamp comprises a heating means which heats the melting means upon detection of an explosion of the burner (10)

6. The lamp according to claim 1, wherein the lamp comprises at least one sealing means located in the in- and/or outlets of the lamp, which upon detection of an explosion of the burner, seals the in- and/or outlets of the lamp.

7. The lamp according to claim 1, whereby the sealing means comprises at least one retaining means, which hold the sealing means in a position, which allows fluid to flow through the in- and/or outlets of the lamp in case the burner (10) of the lamp is in usual operation (1) but allow the sealing means to seal the in- and/or outlets of the lamp in case the burner (10) explodes.

8. The lamp according to claim 1, whereby the closing means comprise at least one first closing means, which immediately close the in- and/or outlets of the lamp and at least one second closing means, which hermetically and/or irreversibly close the in- and outlets of the lamp.

9. The lamp according to claim 1, whereby the closing means may comprise a warning and/or signaling means, which issues a warning signal upon detection of an explosion of the burner of the lamp.

10. A system incorporating a lamp according to claim 1 and being used in one or more of the following applications:
shop lighting,
home lighting,
head lamps
accent lighting,
spot lighting,
theater lighting,
Office lighting
Illumination of workplaces
Automotive front lighting
Automotive auxiliary lighting
Automotive interior lighting
consumer TV applications,
fiber-optics applications, and
projection systems.
